(19) United States
(12) Patent Application Publication
(10) Pub. No.: US 2018/0266319 A1
(43) Pub. Date: Sep. 20, 2018

(54) LIQUID-GAS SEPARATOR MEDIA

(71) Applicant: General Electric Company, Schenectady, NY (US)

(72) Inventors: Valery Ivanovich PONYAVIN, Greenville, SC (US); Naveen Ghattadhahalli Parmeshwar, Greenville (SC); Christopher Conard Frese, Greenville, SC (US); Hua Zhang, Greer, SC (US); Bradly Aaron Kippel, Greer, SC (US)

(21) Appl. No.: 15/463,624

(22) Filed: Mar. 20, 2017

(51) Int. Cl. F02C 7/055; B01D 46/00; B01D 46/12

(52) U.S. Cl. CPC F02C 7/055; B01D 46/0023; B01D 2267/30; B01D 46/12; B01D 46/003

(57) ABSTRACT

The present application provides a gas turbine engine. The gas turbine engine may include a compressor, an inlet filter house positioned upstream of the compressor, and one or more inlet water separator pads positioned within the inlet filter house. The one or more inlet water separator pads may include a synthetic liquid-gas separator media.

### TECHNICAL FIELD

The present application and the resultant patent relate generally to a liquid-gas separator media and more particularly relate to a liquid-gas separator media used in different locations in turbo-machinery to remove liquid from a gas stream with a low pressure drop therethrough.

### BACKGROUND OF THE INVENTION

A conventional gas turbine engine includes a compressor for compressing a flow of ambient air, a combustor for mixing the compressed flow of ambient air with a flow of fuel to create a flow of hot combustion gases, and a turbine that is driven by the hot combustion gases to produce mechanical work. The turbine may drive a load such as a generator for electrical power.

Various types of inlet air filtration systems may be used upstream of the compressor. The incoming air flow may contain fluid particles, such as water, that may affect the performance of the gas turbine engine or other type of power generation equipment. Such fluid particles may reduce the life expectancy and performance of the gas turbine engine and other types of power generation equipment. To avoid these problems, the inlet air may pass through a series of filters and screens to assist in removing the fluid particles from the airstream.

Similarly, the fuel in a gas turbine engine also may benefit from the removal of water therein. For example, a fuel conditioning system may provide a flow of fuel to a fuel nozzle at a substantially constant pressure. If, for example, the natural gas supply pressure is too high, the fuel conditioning system may need to reduce the pressure before the flow of fuel reaches the nozzle. Such a reduction in pressure, however, may cause ice and hydrate formation in the flow of fuel. Hydrates in the flow of fuel may cause nozzle erosion, flashback, and other types of combustion issues.

### SUMMARY OF THE INVENTION

The present application and the resultant patent thus provide a gas turbine engine. The gas turbine engine may include a compressor, an inlet filter house positioned upstream of the compressor, and one or more inlet water separator pads positioned within the inlet filter house. The one or more inlet water separator pads may include a synthetic liquid-gas separator media.

The present application and the resultant patent further provide a method of method of operating a gas turbine engine. The method may include the steps of providing a flow of air to a compressor, providing a flow of fuel to a combustor, flowing the air through an air liquid-gas separator media upstream of the compressor, flowing the fuel through a fuel liquid-gas separator media upstream of the combustor, and combusting the flow of air and the flow of fuel.

The present application and the resultant patent further provide a gas turbine engine. The gas turbine engine may include a combustor and a fuel conditioning system positioned upstream of the combustor. The fuel conditioning system may include a coalescing filter made from a synthetic liquid-gas separator media.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine with a compressor, a combustor, a turbine, and a load.

FIG. 2 is a schematic diagram of an inlet air system that may be used with the gas turbine engine of FIG. 1.

FIG. 3 is a perspective view of a first side of a synthetic media pad as may be described herein.

FIG. 4 is a perspective view of a second side of the synthetic media pad of FIG. 3.

FIG. 5 is a side view of the synthetic media pad of FIG. 3.

FIG. 6 is a schematic view of a number of the synthetic media pads positioned in a staggered array.

FIG. 7 is a plan view of an alternative embodiment of a synthetic media layer as may be described herein.

FIG. 8 is a schematic diagram of a fuel conditioning system that may be used with the gas turbine engine of 1.

### DETAILED DESCRIPTION

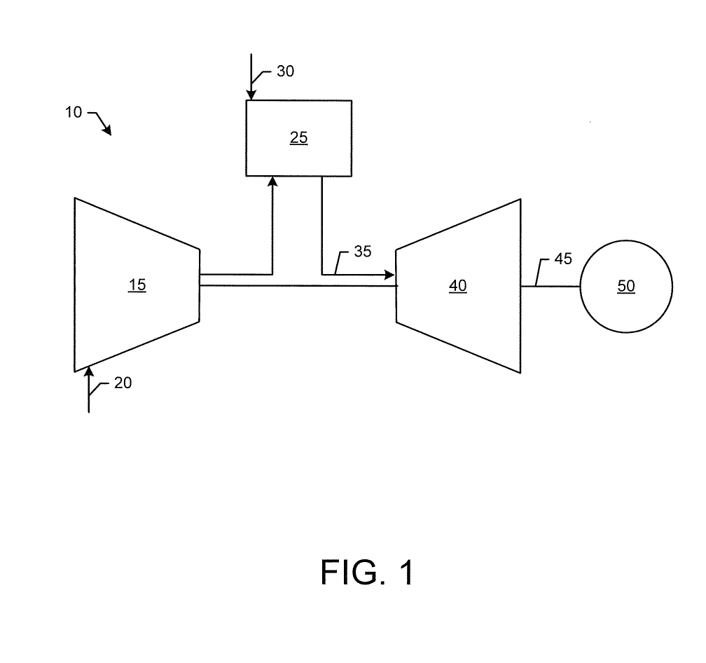

Referring now to the drawings, in which like numerals refer to like elements throughout the several views, FIG. 1 shows a schematic diagram of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25 arranged in a circumferential array or otherwise. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, liquid fuels, various types of syngas, and/or other types of fuels and blends thereof. The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

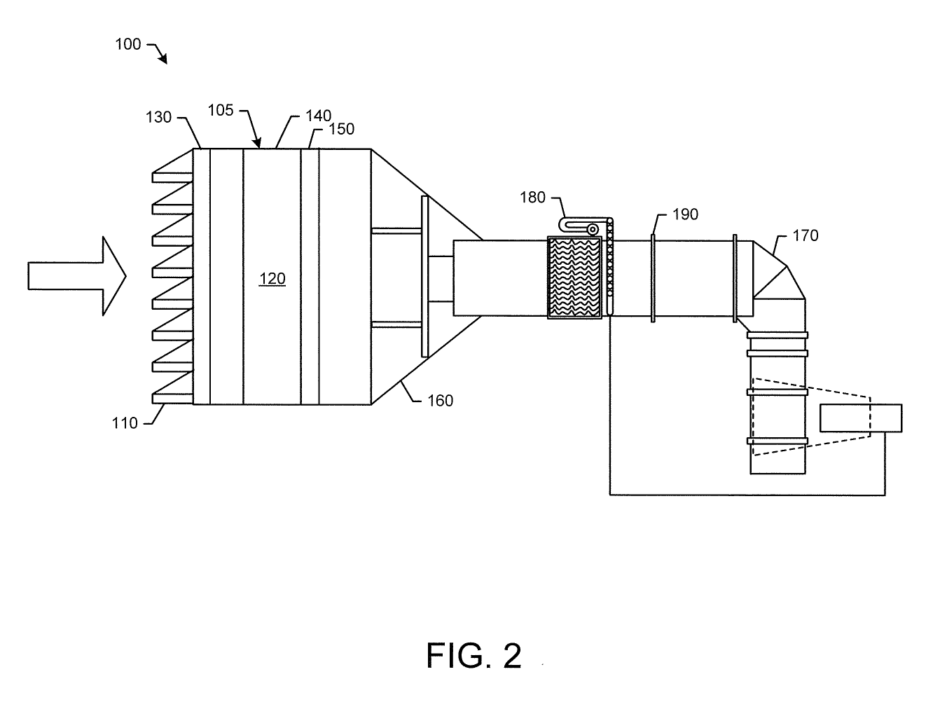

FIG. 2 is a schematic diagram of an example of a turbine component 100. In this example, the turbine component 100 may be a turbine inlet air system 105. The turbine inlet air system 105 may be integrated with the compressor 15 of the gas turbine engine 10 described above and the like. The turbine inlet air system 105 may include a weatherhood 110. The weatherhood 110 may prevent weather elements such as rain, snow, hail, and the like in the flow of air 20 from entering the compressor 15. The weatherhood 110 may be mounted on an inlet filter house 120. The weatherhood 110 and the inlet filter house 120 may have any suitable size, shape, or configuration.

The turbine inlet air system 105 may include an inlet water separator pad 130 positioned within the inlet filter house 120 downstream of the weatherhood 110. The inlet water separator pad 130 may remove water from the incoming air flow 20 as will be described in more detail below. The inlet water separator pad 130 may have any suitable size, shape, or configuration. The turbine inlet air system 105 also may include a power augmentation system 140 positioned within the inlet filter house. 120. As described above, the power augmentation system 140 may cool the incoming flow of air 20 via evaporative cooling and the like. The power augmentation system 140 may include one or more drift eliminator pads 150 so as to prevent water droplets from passing downstream to the compressor 15. The drift eliminator pads 150 may have any suitable size, shape, or configuration.

The turbine inlet air system 105 may include a transition piece 160 extending downstream of the inlet filter house 120 and extending into an inlet duct 170. The inlet duct 1780 may extend to an inlet of the compressor 15. A silencer section 180 may be included to reduce noise generated by the incoming flow of air 20. One or more screens 190 may be included to deflect contaminants and/or debris. The turbine inlet air system 105 described herein is for the purpose of example only. Other components and other configurations may be used herein.

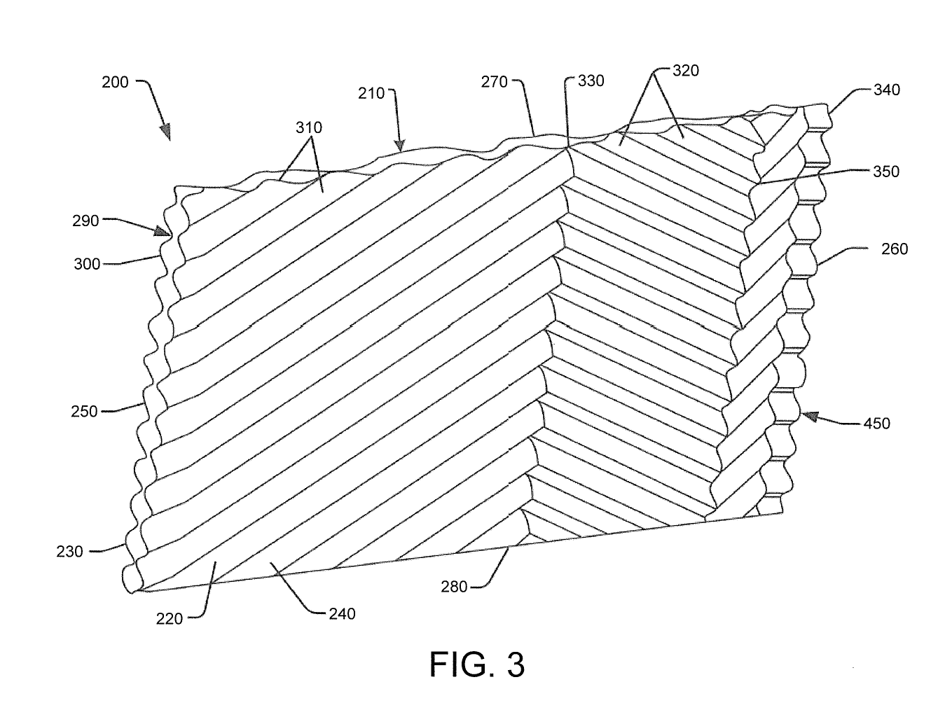

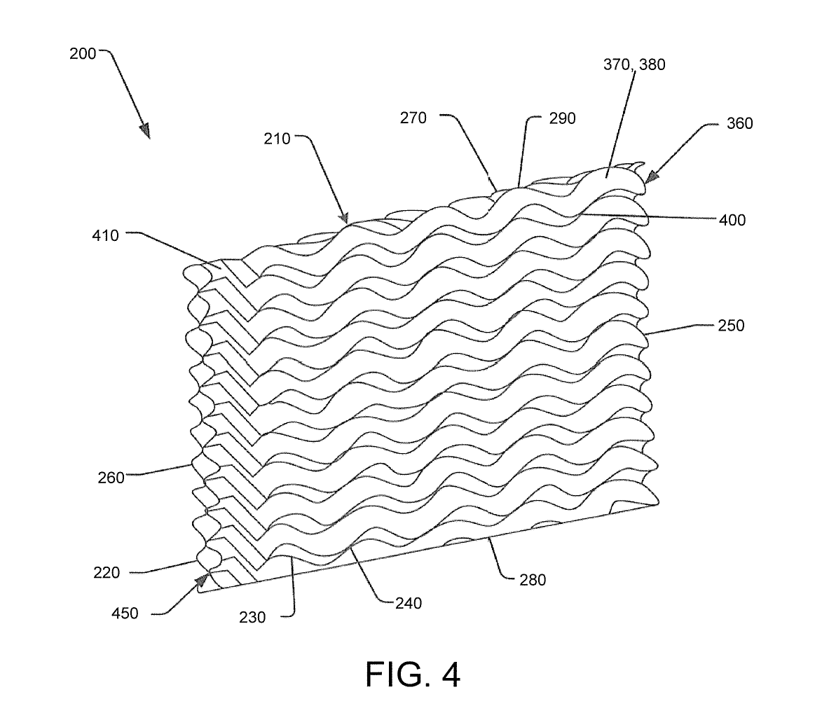

The inlet water separator pads 130 and/or the drift eliminator pads 150 may be made from a liquid-gas separator media 200. As is shown, by example, in FIGS. 3-5, the liquid-gas separator media 200 may include at least a pair of media sheets 210 therein. In this example, a first media sheet 220 and a second media sheet 230 are shown although any number of additional sheets may be used herein. Any number of the media sheets 210 may be used herein in any suitable size, shape, or configuration. The media sheets 210 may be thermally formed from non-woven synthetic fibers with or without hydrophilic surface enhancements. For example, the non-woven synthetic fibers may include polyethylene terephthalate (PET), polytrimethylene terephthalate (PTT), nylon, polyester, polypropylene, and the like. The hydrophilic surface enhancements may include the application of a strong alkaline treatment under high processing temperatures, polyvinyl alcohol in an alkaline medium, and the like. Other materials and treatments may be used herein. The media sheets 210 may be wetable so as to accept, absorb, flow, and distribute water droplets and the like in the incoming air flow 20.

Generally described, the media sheets 210 may have a substantially three dimensional contoured shape 240. Specifically, the media sheets 210 may include a leading edge 250 facing the incoming inlet air flow 20 and a downstream trailing edge 260 facing about the compressor 12. Likewise, the media sheets 210 may have a top edge 270 in communication or not with a flow of water or other coolant and a bottom edge 280 positioned about a drain and the like.

In this example, the first media sheet 220 may have a chevron like corrugated surface 290. The chevron like corrugated surface 290 may have a number of chevron channels 300 therein. Any number of the chevron channels 300 may be used herein in any suitable size, shape, or configuration. Specifically, the chevron channels 300 may have a diagonally rising portion 310 and a diagonally lowering portion 320. The diagonally rising portion 310 may extend from the leading edge 250 and meet the diagonally lowering portion 320 about an apex 330 thereof. The angle of the rising and the lowering portions may vary. Optionally, each of the chevron channels 300 may end in a first side mist eliminator portion 340. The first side mist eliminator portions 340 may extend diagonally upward in a sharp angle at a nadir 350 of each of the diagonally lowering portions 320. The first side mist eliminator portions 340 may extend from the nadir 350 towards the trailing edge 260. Other components and other configurations may be used herein.

The second media sheet 230 may have a wavy corrugated surface 360. Specifically, the wavy corrugated surface 360 may have a number of wavy channels 370. Any number of the wavy channels 370 may be used herein in any size, shape, or configuration. Specifically, the wavy channels 370 may have a substantially sinusoidal like shape 380 with a number of peaks 390 and valleys 400. Optionally, the wavy channels 370 may extend from the leading edge 250 to a second side mist eliminator portion 410. The second side mist eliminator portions 410 may extend diagonally upward in a sharp angle from one of the valleys 400 of the sinusoidal like shape 380. The second side mist eliminator portions 410 may extend from the valley 400 towards the trailing edge 260. Other components and other configurations may be used herein.

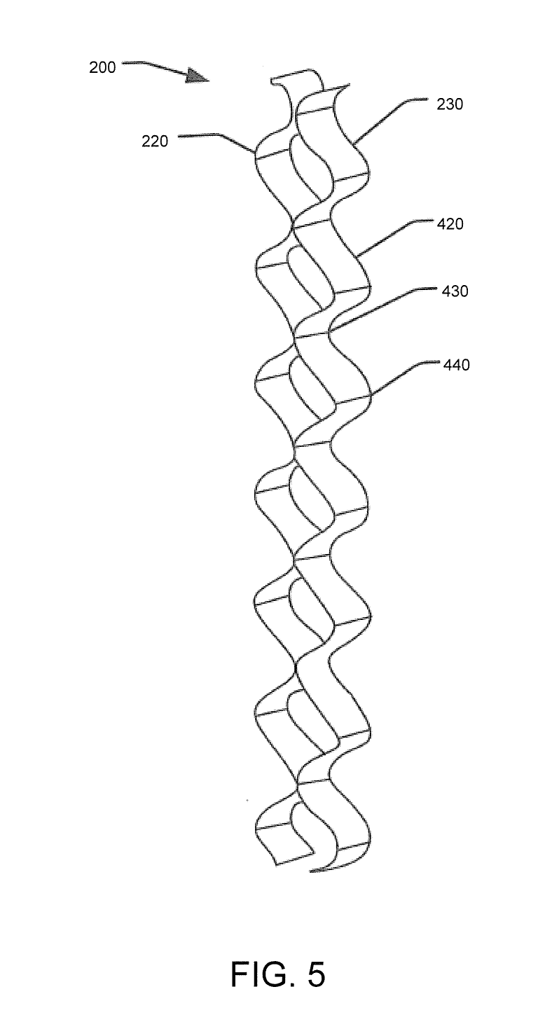

FIG. 5 shows a first media sheet 220 bound to a second media sheet 230. The leading edge 250 thus forms a diamond like shape 420. The diamond like shape 420 may include a bonding portion 430 where the media sheets 220, 230 may meet and may be bonded via glue and the like and an expanded portion 440 for good airflow therethrough. The trailing edge 260 likewise may include the diamond like shape 420 for good air flow therethrough. Optionally, the first side mist eliminator portion 340 and the second side mist eliminator portion 410 may combine to form an integrated mist eliminator 450 of a substantially uniform shape about the trailing edge 260. Other components and other configurations may be used herein.

In use in these examples, the liquid-gas separator media 200 may function as the inlet water separator pad 130 and/or the mist eliminator pad 150 and/or the like. The liquid-gas separator media 200 may act as an inertial separator to remove water droplets from the incoming air flow 20 and may direct the droplets to a drain or elsewhere. A portion of the water droplets also may be evaporated therein. Specifically, the inlet air flow 20 may enter via the leading edge 250. The liquid-gas separator media 200 may catch any water droplets in the flow of air 20 and may absorb the water droplets through capillary action. The absorption of the water droplets into the liquid-gas separator media 200 also may enable an increase in overall airstream velocity. The use of the diamond like shape 420 at the leading edge 250 and the trailing edge 260 also serves to reduce air pressure losses therethrough. The liquid-gas separator media 200 thus may eliminate the use of other types of materials, reduce the depth of the filter house with a simplified construction, increase air velocity with a lower pressure drop, and increase overall efficiency.

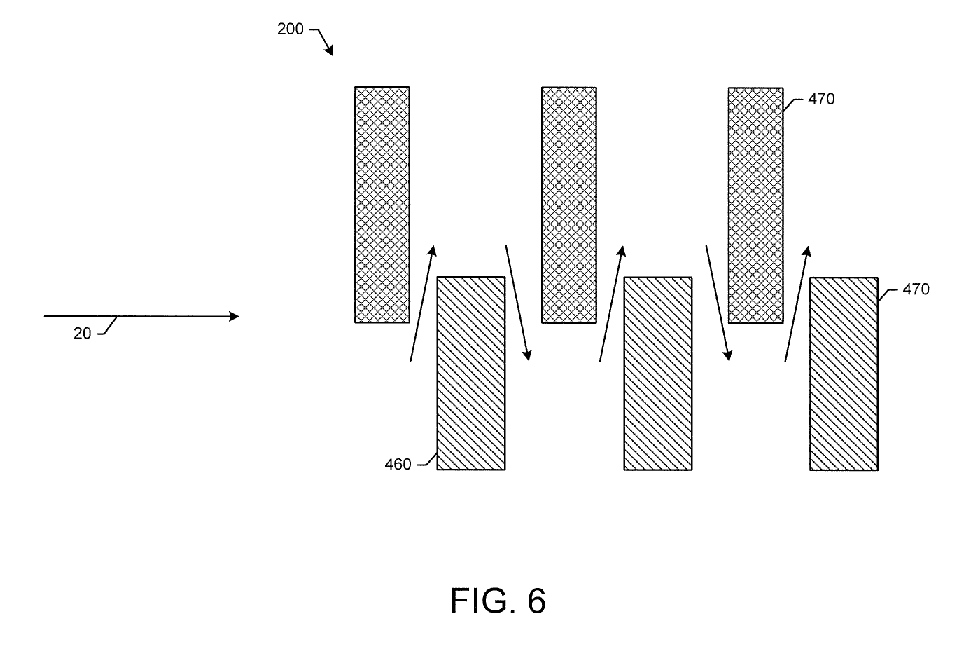

FIG. 6 shows the use of the liquid-gas separator media 200 in the form of a staggered array 460 of media pads 470. The use of the staggered array 460 may increase the volume of the water droplets removed from the incoming air flow 20 with the addition of inertial forces caused by the positioning of the media pads 470. The additional inertial forces caused by the staggered array 460 may promote additional coalescence of the water droplets for increased draining via gravity and the like. The nature of the staggered array 460 may vary. Any number of the media pads 470 may be used herein. Other components and other configurations may be used herein.

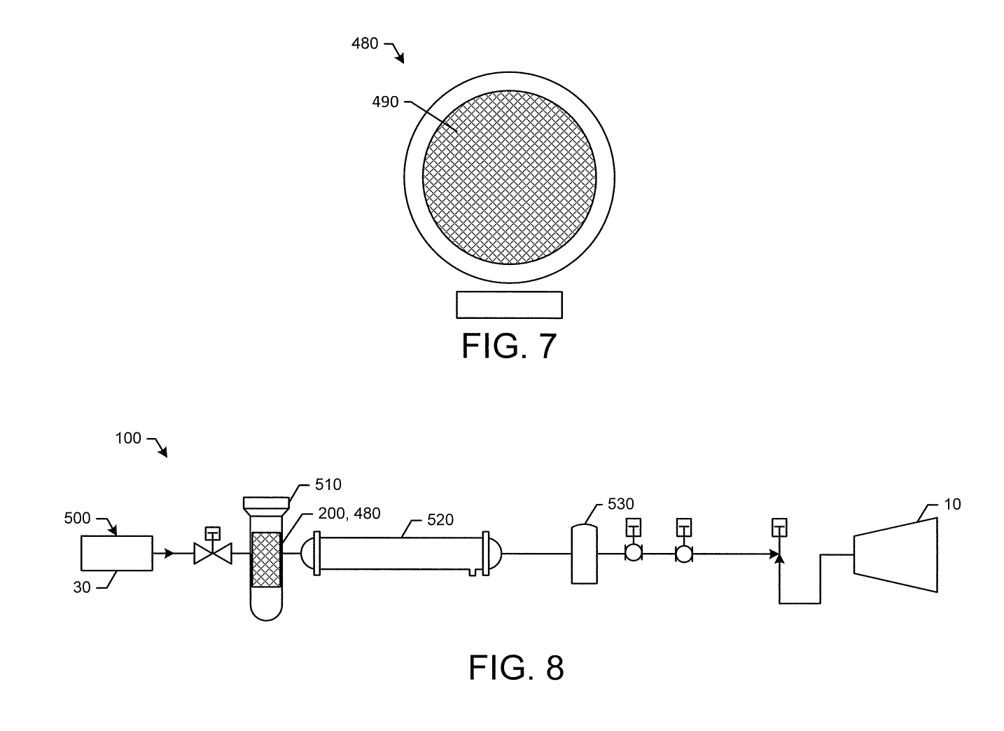

FIG. 7 shows an alternative embodiment of a liquid-gas separator media 480. Instead of the media sheets 210 described above, the liquid-gas separator media 480 may be a substantially uniform low density synthetic media 490. The synthetic media 490 may be made out of similar materials as described above. The synthetic media 490 may be effective at removing water droplets in the incoming air flow 20 but may cause a larger pressure drop given the substantially uniform configuration. Other components and other configurations may be used herein.

FIG. 8 shows a further turbine component 100 as may be described herein. In this example, the turbine component 100 may be a fuel condition system 500. Generally described, the fuel conditioning system 500 may provide the flow of fuel 30 to one or more of the nozzles of the combustor 25. The flow of fuel 30 may flow through a coalescing filter 510. The coalescing filter 510 may eliminate mist and/or water droplets from the flow of fuel 30. The flow of fuel 30 then may be heated in a performance heater 520. The performance heater 90 generally warms the flow of fuel 30 with waste heat or heat from another source in a heat exchange arrangement and the like. The fuel conditioning system 500 also may include a scrubber 530 so as to remove any further moisture before entry into the nozzle of the combustor 25. Other components and other configurations may be used herein.

In this example, the coalescing filter 510 may use one of the liquid-gas separator media 200, 480 described above. The liquid-gas separator media 200, 480 may be effective in removing water droplets and the like from the flow of fuel 30 in a manner similar to the flow of air 20.

Although the liquid-gas separator media 200, 480 has been described in the context of removing water droplets from the flow of air 20 and the flow of fuel 30 in the different types of turbine components 100 described above, the liquid gas separator media 200, 480 may be effective in removing water droplets and other liquids in a gas stream of any sort in a wide variety of applications. The liquid-gas separator media 200, 480 may be formed in a way to trap particles effectively (traps in the media using heated platen method) or formed in a way to optimize uniform air flow distribution. Different types of the liquid-gas separator media 200, 480 may be used herein together.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A gas turbine engine, comprising:
a compressor;
an inlet filter house positioned upstream of the compressor; and
one or more inlet water separator pads positioned within the inlet filter house;
the one or more inlet water separator pads comprising a synthetic liquid-gas separator media.

2. The gas turbine engine of claim 1, wherein the one or more inlet water separator pads are configured in a staggered array.

3. The gas turbine engine of claim 1, wherein the inlet filter house comprises a power augmentation system.

4. The gas turbine engine of claim 3, wherein the one or more inlet water separator pads comprise a drift eliminator pad.

5. The gas turbine engine of claim 1, further comprising a fuel conditioning system with the synthetic liquid-gas separator media therein.

6. The gas turbine engine of claim 5, wherein the liquid-gas separator media comprises a coalescing filter.

7. The gas turbine engine of claim 1, wherein the synthetic liquid-gas separator media comprises:
a first media sheet;
the first media sheet comprising a chevron corrugated surface; and
a second media sheet;
the second media sheet comprising a wavy corrugated surface.

8. The gas turbine engine of claim 7, wherein the first media sheet and the second media sheet extend from a leading edge to a trailing edge.

9. The gas turbine engine of claim 8, wherein the leading edge faces the inlet air flow.

10. The gas turbine engine of claim 8, wherein the chevron corrugated surface and the wavy corrugated surface extend from the leading edge towards the trailing edge.

11. The gas turbine engine of claim 8, wherein the leading edge and the trailing edge comprise a diamond like shape.

12. The gas turbine engine of claim 11, wherein the diamond like shape comprises a bonding portion and an expanded portion.

13. The gas turbine engine of claim 7, wherein the chevron corrugated surface comprises a plurality of chevron channels with diagonally rising portions and diagonally lowering portions.

14. The gas turbine engine of claim 7, wherein the wavy corrugated surface comprises a plurality of wavy channels with peaks and valleys.

15. A method of operating a gas turbine engine, comprising:
providing a flow of air to a compressor;
providing a flow of fuel to a combustor;
flowing the air through an air liquid-gas separator media upstream of the compressor;
flowing the fuel through a fuel liquid-gas separator media upstream of the combustor; and
combusting the flow of air and the flow of fuel.

16. A gas turbine engine, comprising:
a combustor;
a fuel conditioning system positioned upstream of the combustor;
the fuel conditioning system comprising a coalescing filter; and
the coalescing filter comprising a synthetic liquid-gas separator, media.

17. The gas turbine engine of claim 16, wherein the synthetic liquid-gas separator media comprises a first media sheet with a plurality of chevron channels and a second media sheet with a plurality of wavy channels.

18. The gas turbine engine of claim 16, wherein the first media sheet and the second media sheet extend from a leading edge to a trailing edge and wherein the leading edge and the trailing edge comprise a diamond like shape.

19. The gas turbine engine of claim 16, wherein the plurality of chevron channels comprises diagonally rising portions and diagonally lowering portions and wherein the plurality of wavy channels comprises peaks and valleys.

20. The gas turbine engine of claim 16, further comprising an inlet filter house and wherein the inlet filter house comprises the synthetic liquid-gas separator media therein.
